(19) United States
(12) Patent Application Publication
(10) Pub. No.: US 2015/0035337 A1
(43) Pub. Date: Feb. 5, 2015

(54) SEAT RECLINING APPARATUS FOR VEHICLE

(71) Applicant: AISIN SEIKI KABUSHIKI KAISHA, Kariya-shi (JP)

(72) Inventors: Yukifumi YAMADA, Toyota-shi (JP); Yasuhiro Kojima, Kariya-shi (JP); Naoki Goto, Tokai-shi (JP)

(73) Assignee: AISIN SEIKI KABUSHIKI KAISHA, Kariya-shi (JP)

(21) Appl. No.: 14/328,068

(22) Filed: Jul. 10, 2014

(30) Foreign Application Priority Data
Jul. 31, 2013 (JP) 2013-159596

(51) Int. Cl. B60N 2/235

(52) U.S. Cl. CPC B60N 2/2356
USPC 297/367 P

(57) ABSTRACT

A seat reclining apparatus for a vehicle includes a first bracket, a plurality of pawls, a second bracket being relatively rotatably placed to face the first bracket, a cam mechanism having outer teeth of each of the pawls engage with and disengage from inner teeth of the first bracket by moving each of the pawls in the radial direction by rotating a cam member, the first bracket including a first circumferential wall portion and a second circumferential wall portion which are formed to include different levels from each other by a deformation processing, and a step portion serving as a fit-in portion and being fitted-in a fit-in recessed portion being provided at a fixed object of a seat, and the step portion including a welding portion at a circumferential edge of the step portion to be welded to the fixed object.

### CROSS REFERENCE TO RELATED APPLICATIONS

This application is based on and claims priority under 35 U.S.C. §119 to Japanese Patent Application 2013-159596, filed on Jul. 31, 2013, the entire content of which is incorporated herein by reference.

### TECHNICAL FIELD

This disclosure generally relates to a seat reclining apparatus for a vehicle.

### BACKGROUND DISCUSSION

Many of known seats for vehicles include seat reclining apparatuses which are able to adjust a tilt angle, or an inclined angle of a seatback relative to a seat cushion of the seat for the vehicle. For example, a seat reclining apparatus disclosed in JP2008-289699A (hereinafter referred to as Patent reference 1) is provided with a first bracket (ratchet plate), plural pawls, and a second bracket (base plate). The first bracket includes inner teeth on an annular inner circumference. The plural pawls include outer teeth which selectively engage with the inner teeth of the first bracket. The second bracket includes a guide portion which holds the pawl moving in a radial direction, The second bracket is placed in juxtaposition with the first bracket in a relatively movable manner. In addition, the seat reclining apparatus disclosed in Patent reference 1 includes a cam mechanism which has the outer teeth of the pawl selectively engage with the inner teeth of the first bracket by moving each of the pawls in the radial direction by rotating a cam member which is provided radially inward of each of the pawls. According to Patent reference 1, the first bracket is fixed to the seatback, whereas the second bracket is fixed to the seat cushion.

Each of the pawls moves outwardly in the radial direction to mesh (engage) the outer teeth with the inner teeth of the first bracket to restrict the relative rotation between the first bracket and the second bracket (a locked state). On the other hand, each of the pawls moves inwardly in the radial direction to disengage the outer teeth from the inner teeth of the first bracket so that the first bracket and the second bracket relatively rotate with each other (an unlock state). When the seat reclining apparatus is in the unlocked state, the tilt angle of the seatback may be adjusted.

According to Patent reference 1, an outer surface of the first bracket includes plural protrusions which protrude in a thickness direction of the first bracket. The first bracket is fixed to a fixed object of the seatback (upper arm), and the fixed object includes a fit-in recessed portion which fits in each of the protrusions of the first bracket (see FIG. 5 and FIG. 10 of Patent reference 1). Accordingly, the relative rotation between the first bracket and the fixed object is restricted.

According to the aforementioned Patent reference 1, the seat reclining apparatus is positioned between the seatback and the seat cushion. In order to downsize the seat for the vehicle while strengthening the support stiffness, the seat reclining apparatus which includes a rotation shaft of the seat may preferably be configured to be thinner to decrease the distance between the respective fixed objects of the seatback and the seat cushion. However, considering the strength of the seat reclining apparatus, there is a limit to reduce the thickness of the bracket and the pawls.

A need thus exists for a seat reclining apparatus for a vehicle which is not susceptible to the drawback mentioned above.

### SUMMARY

According to an aspect of this disclosure, a seat reclining apparatus for a vehicle includes a first bracket including inner teeth at an annular inner circumferential surface of the first bracket, a plurality of pawls including outer teeth which engage with and disengage from the inner teeth, a second bracket including a guide portion which holds each of the pawls, the pawls which move in a radial direction, the second bracket being relatively rotatably placed to face the first bracket, a cam member being provided radially inward of the pawls, a cam mechanism having the outer teeth of each of the pawls engage with and disengage from the inner teeth of the first bracket by moving each of the pawls in the radial direction by rotating the cam member, the first bracket including a first circumferential wall portion and a second circumferential wall portion which are formed to include different levels from each other by a deformation processing, the first bracket including the inner teeth at the first circumferential wall portion, and a step portion being formed by pushing the first bracket toward an outer surface of the first bracket when forming the second circumferential wall portion, the step portion serving as a fit-in portion and being fitted-in a fit-in recessed portion being provided at a fixed object of a seat, and the step portion including a welding portion at a circumferential edge to be welded to the fixed object.

### BRIEF DESCRIPTION OF THE DRAWINGS

The foregoing and additional features and characteristics of this disclosure will become more apparent from the following detailed description considered with the reference to the accompanying drawings, wherein:

FIG. 1 shows a perspective view of a seat for a vehicle according to first, second and third embodiments disclosed here;

FIG. 2 shows a front view of the seat for the vehicle according to the first, second and third embodiments;

FIG. 3 shows a cross-sectional view of the seat for the vehicle taken along line III-Ill in FIG. 2;

FIG. 4 shows a cross-sectional view of a seat reclining apparatus for the vehicle taken along line IV-IV in FIG. 3 showing a fixing structure of the seat reclining apparatus;

FIG. 5 shows a cross-sectional view of the seat reclining apparatus for the vehicle taken along line V-V in FIG. 4;

FIG. 6 shows a cross-sectional view of the seat reclining apparatus for the vehicle taken along line VI-VI in FIG. 4;

FIG. 7 shows a cross-sectional view of the seat reclining apparatus for the vehicle taken along line VII-VII in FIG. 5;

FIG. 8 shows a front view of the seat reclining apparatus for the vehicle showing the fixing structure of the seat reclining apparatus;

FIG. 9 shows a front view of a seat reclining apparatus for a vehicle showing a fixing structure of the seat reclining apparatus of a second embodiment;

FIG. 10 shows a cross-sectional view of the seat reclining apparatus for the vehicle showing the fixing structure of the seat reclining apparatus of the second embodiment;

FIG. 11 shows a front view of a seat reclining apparatus for a vehicle showing a fixing structure of the seat reclining apparatus of a third embodiment; and

FIG. 12 shows a cross-sectional view of the seat reclining apparatus for the vehicle showing the fixing structure of the seat reclining apparatus of the third embodiment.

### DETAILED DESCRIPTION

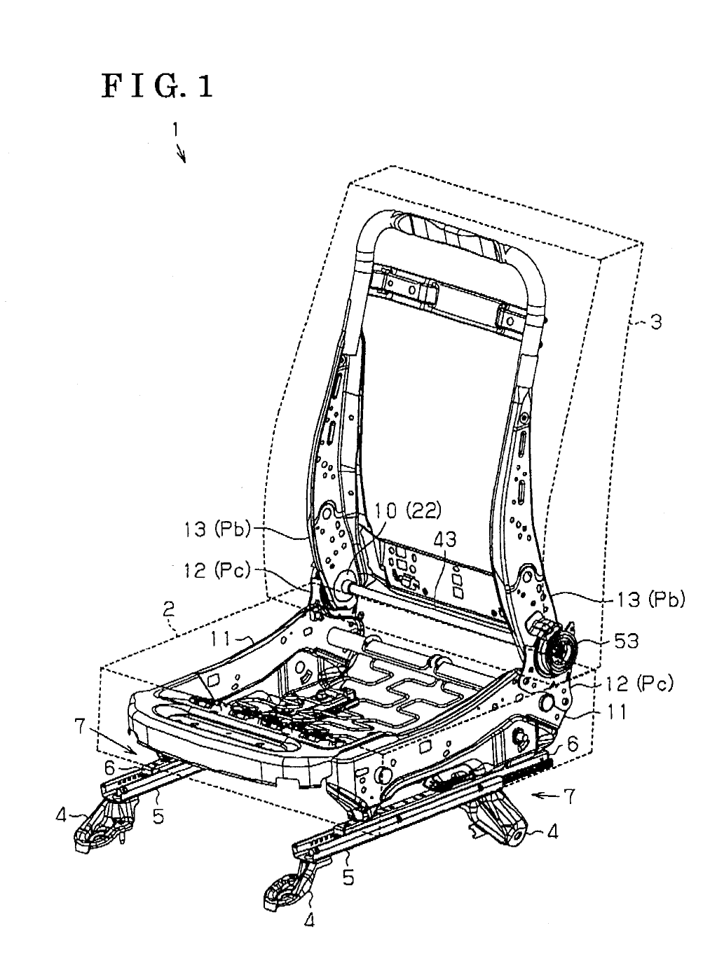

Embodiments of a seat reclining apparatus 10 for a vehicle will be described hereunder referring to the drawings. As shown in FIG. 1, a seat 1 for the vehicle includes a seat cushion 2 and a seatback 3 which tilts, or inclines relative to a rear end portion of the seat cushion 2.

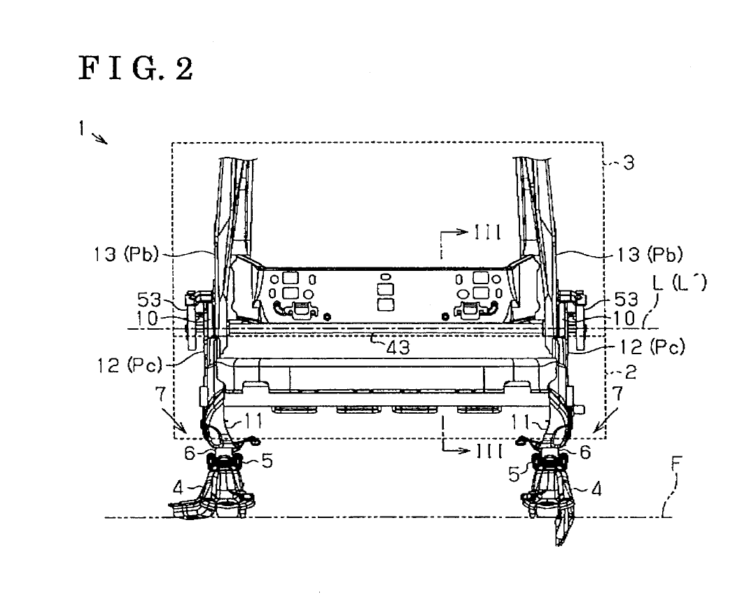

As shown in FIG. 1 and FIG. 2, in the embodiment, a right-left pair of lower rails 5 is provided on a floor portion F of the vehicle and is supported on each of brackets 4. An upper rail 6 is mounted on the lower rail 5 and relatively moves with the lower rail 5. The seat 1 is supported on the upper rails 6.

That is, in the embodiment, a seat sliding apparatus 7 is provided with the lower rail 5 and the upper rail 6 which relatively move with each other. An operator of the vehicle can adjust a position of the seat 1 in a vehicle front-rear direction by using the seat sliding apparatus 7.

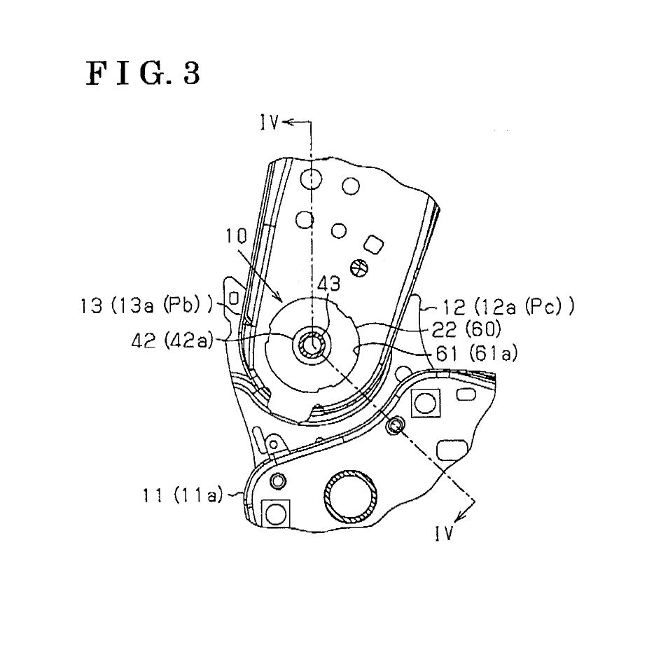

As shown in FIG. 2 and FIG. 3, the seat reclining apparatus 10 is positioned between the seat cushion 2 and the seatback 3, and selectively restricts the relative rotation of the seatback 3 relative to the seat cushion 2. The operator of the vehicle can adjust a tilt angle, or an inclined angle of the seatback 3 by using the seat reclining apparatus 10.

In detail, according to the embodiment shown in FIG. 1 to FIG. 4, a side frame 11 forms a framework of each of opposing sides of the seat cushion 2 in a width direction (right-left direction in FIG. 2). Each of the side frames 11 includes a support bracket 12 extending upwardly from a rear end portion 11a of the side frame 11. The seatback 3 is configured such that a seatback side member 13 forms a framework of each of opposing sides of the seat back 3 in the width direction and is positioned inward relative to the support bracket 12 in the width direction. The seat reclining apparatuses 10 are positioned at the opposing sides of the seatback 3 in the width direction. The seat reclining apparatus 10 is positioned between an upper end portion 12a of the support bracket 12 and a base end 13a of the seatback side member 13, the upper end portion 12a and the base end 13a which face with each other in the width direction of the seat reclining apparatus 10.

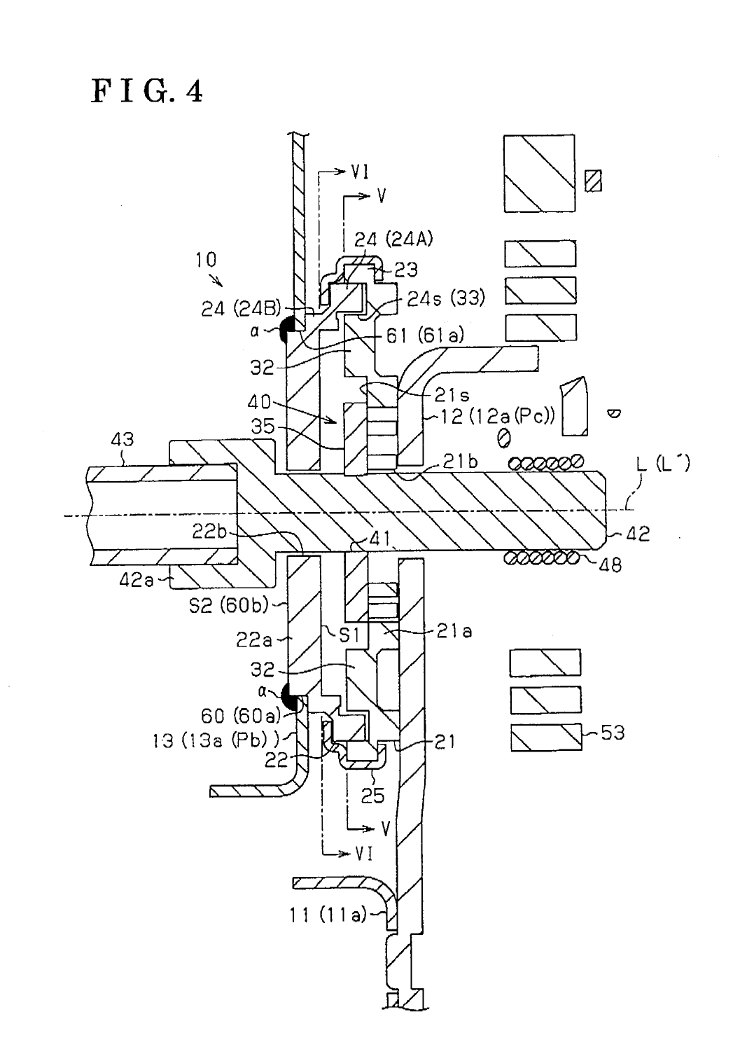

Further in detail, as shown in FIG. 4 to FIG. 7, the seat reclining apparatus 10 of the embodiment is provided with an upper bracket 22 (serving as a first bracket) and a lower bracket 21 (serving as a second bracket) which include a coaxial pivot center (rotation axis and are placed to face with each other to be relatively rotatable with each other.

According to the embodiment, the lower bracket 21 and the upper bracket 22 are formed in a substantially disc shape. The lower bracket 21 includes a body portion 21a and an annular circumferential wall portion 23, whereas the upper bracket 22 includes a body portion 22a and an annular circumferential wall portion 24. The body portion 21a of the lower bracket 21 and the body portion 22a of the upper bracket 22 face with each other. The circumferential wall portion 23 protrudes from the body portion 21a toward the circumferential wall portion 24 while the circumferential wall portion 24 protrudes from the body portion 22a toward the circumferential wall portion 23. The lower bracket 21 and the upper bracket 22 are coaxially positioned so as to be relatively rotatable with each other by fitting-in the respective circumferential wall portions 23, 24 with each other.

In particular, the circumferential edge portion of the upper bracket 22 is provided with a first circumferential wall portion 24A and a second circumferential wall portion 24B which are formed to include different levels from each other, or formed in a stepwise manner. In the embodiment, an outer diameter of the first circumferential wall portion 24A which is positioned radially outward is set to be substantial equal to an inner diameter of the circumferential wall portion 23 of the lower bracket 21. The upper bracket 22 relatively rotates with the lower bracket 21 in a state where the first circumferential wall portion 24A is slidably in contact with the circumferential wall portion 23 of the lower bracket 21, the circumferential wall portion 23 which is positioned radially outward.

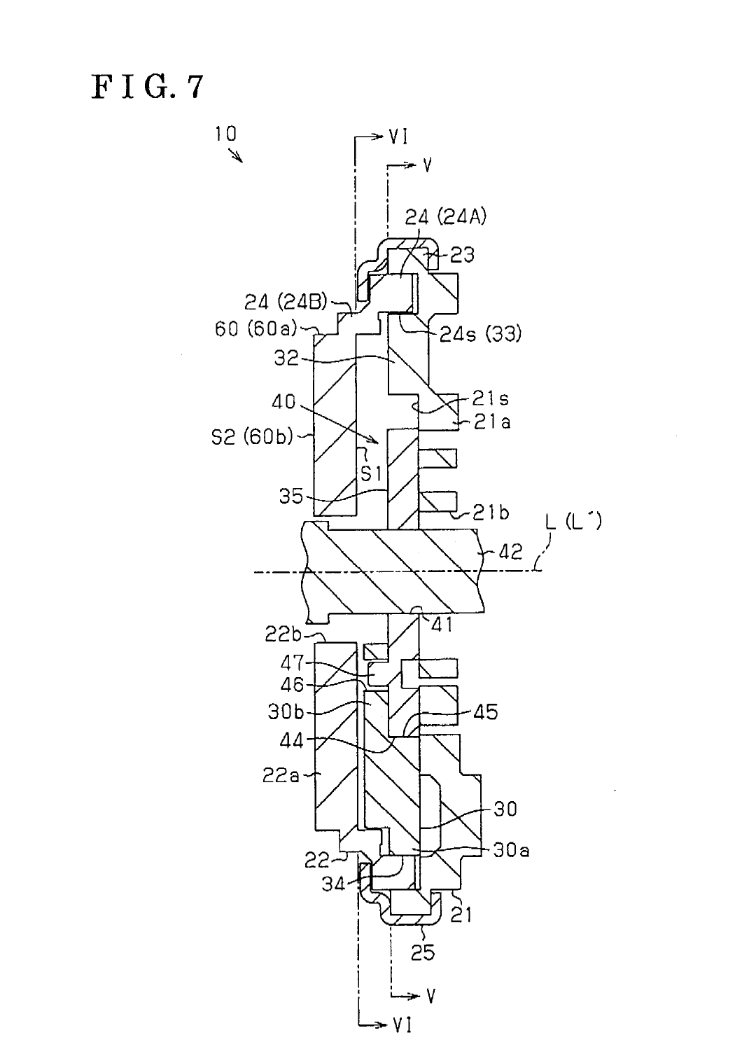

The seat reclining apparatus 10 of the embodiment is provided with an annular holder 25 which includes a cross-sectional shape and binds the circumferential wall portion 23 of the lower bracket 21 and the first circumferential wall portion 24A of the upper bracket 22 in a thickness direction (right-left direction in FIG. 4 and FIG. 7). According to the embodiment, the annular holder 25 fits-in and fixes with each of the outer circumferences of the lower bracket 21 and the upper bracket 22 so that the annular holder 25 allows the relative rotation between the lower bracket 21 and the upper bracket 22 while restricting the relative movement between the lower bracket 21 and the upper bracket 22 along the rotation axis L.

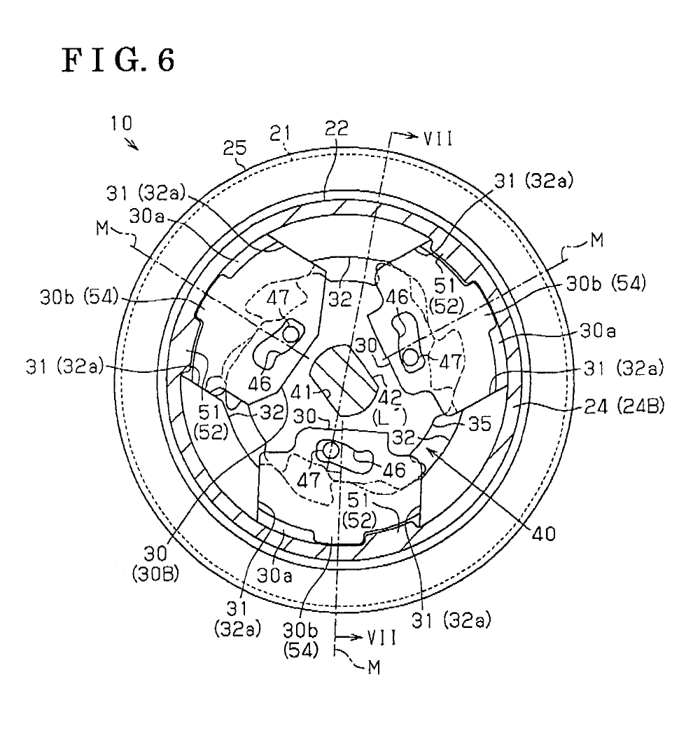

As shown in FIG. 4, in the embodiment, the lower bracket 21 is fixed to the upper end portion 12a of the support bracket 12 which corresponds to a fixed object Pc of the seat cushion 2, whereas the upper bracket 22 is fixed to the base end 13a of the seatback side member 13 which corresponds to a fixed object Pb of the seatback 3. As shown in FIG. 6 and FIG. 7, plural pawls 30 (for example, three, in the embodiment) are interposed between the lower bracket 21 and the upper bracket 22. The pawl 30 restricts the relative rotation of the lower bracket 21 and the upper bracket 22 by being engaged therewith.

In detail, as shown in FIG. 4 to FIG. 7, the lower bracket 21 is provided with a guide portion 31 at radially inward of the circumferential wall portion 23. The guide portion 31 holds the pawl 30 which moves in the radial direction. Each of the pawls 30 of the embodiment is formed in a plate shape. Further, an opposing surface 21s (a left side surface of the lower bracket 21 in FIG. 4 and FIG. 7) of the lower bracket 21 faces the upper bracket 22 in an axial direction of the rotation axis L and includes, for example, three holding protrusions 32 which are substantially equally spaced with each other in the circumferential direction. Each of the holding protrusions 32 is formed in a substantially fan-shape so that all opposing side wall portions 32a which face with each other in the circumferential direction are configured to be substantially parallel to each other. Each of the pawls 30 is positioned between the holding protrusions 32.

That is, according to the embodiment, the pawls 30 are interposed between the side wall portions 32a of the holding protrusions 32 which are adjacent to each other in the circumferential direction. Thus, the side wall portion 32a serves as the guide portion 31. The pawl 30 is slidably in contact with the side wall portions 32a of the holding protrusions 32 which are positioned opposing sides in the circumferential direction. The pawl 30 moves in the radial direction along the side wall portions and is restricted the relative movement relative to the lower bracket 21 in the circumferential direction by being in contact with the side wall portions 32a. As such, the pawl 30 is held at the lower bracket 21.

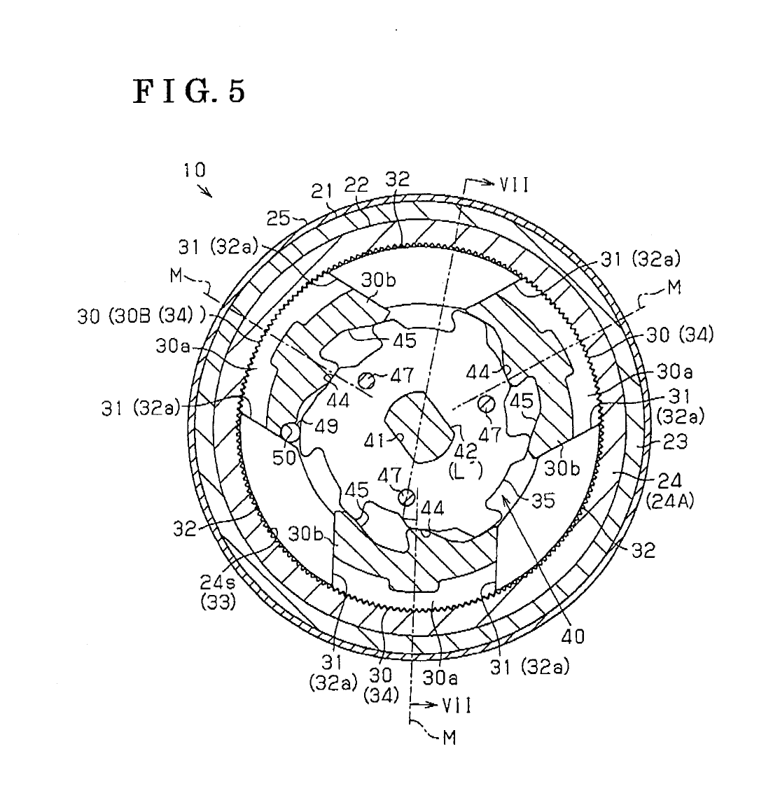

As shown in FIG. 5, the circumferential wall portion 24 of the upper bracket 22, specifically, the first circumferential portion 24A of the upper bracket 22 includes inner teeth 33 which protrude inwardly in the radial direction throughout the whole circumference of an annular inner circumferential surface 24s. Further, the pawl 30 is held by the lower bracket 21 and includes outer teeth 34 which are provided at an end portion of the pawl 30, the end portion which faces outwardly in the radial direction. The outer teeth 34 mesh with the inner teeth 33 which are provided at the inner circumferential surface 24s of the first circumferential wall portion 24A. In the embodiment, the outer teeth 34 of the pawl 30 mesh (engage) with the inner teeth 33 of the upper bracket 22 so that the relative rotation between the lower bracket 21 which holds the pawl 30 and the upper bracket 22 is restricted.

A cam member 35 is rotatably positioned radially inward of the pawl 30 to be in contact with a base portion of the pawl 30, In addition, the seat reclining apparatus 10 of the embodiment includes a cam mechanism 40 which has the outer teeth 34 of the pawl 30 selectively engage with the inner teeth 33 of the upper bracket 22 by moving the pawl 30 in the radial direction by rotating the cam member 35.

According to the embodiment, the upper bracket 22 configures the first bracket, whereas the lower bracket 21 configures the second bracket. The lower bracket 21 holds the pawl 30 which moves outwardly in the radial direction in response to the movement of the cam mechanism 40. Then, the outer teeth 34 of the pawl 30 mesh (engage) with the inner teeth 33 of the upper bracket 22 so that the relative rotation between the upper bracket 22 and the lower bracket 21 is restricted, that is, the seatback 3 is prevented from tilting forward, or inclining forward and backward.

The pawl 30 moves inwardly in the radial direction in response to the movement of the cam mechanism 40 so that the outer teeth 34 of the pawl 30 disengage from the inner teeth 33 of the upper bracket 22. Accordingly, the upper bracket 22 and the lower bracket 21 relatively rotate with each other and the tilt angle of the seat 1 may be adjusted.

As shown in FIG. 4 to FIG. 7, the cam member 35 of the embodiment is formed in a plate shape. A long hole 41 is provided at a center portion of the cam member 35 and includes a pair of inner surfaces (so-called two surfaces in the width direction of the long hole 41) which are positioned in parallel with each other. Then, the long hole 41 is penetrated in the cam member 35 in the thickness direction. The long hole 41 fits-in and fixes with a support shaft 42 which rotates in response to the operation of the operation lever. According to the embodiment, the support shaft 42 is positioned in a through hole 21b which is provided at a center portion of the lower bracket 21, in particular, the body portion 21a of the lower bracket 21, while being positioned in a through hole 22b which is provided at a center portion of the upper bracket 22, in particular, the body portion 22a of the upper bracket 22. Accordingly, the support shaft 42 serves as a rotation shaft L′ and rotates the cam member 35 independently from the lower bracket 21 and the upper bracket 22.

As shown in FIG. 2 and FIG. 4, according to the embodiment, the two seat reclining apparatuses 10 are provided at the opposing sides of the seatback 3 in the width direction and are connected to each other via a connecting rod 43 which is provided coaxially with the support shaft 42. Specifically, opposing ends of the connecting rod 43 in the axial direction are relatively unrotatably fits-in and fixed with cylinder portions 42a which are provided at respective end portions of each of the support shafts 42. According to the embodiment, the right-left pair of the seat reclining apparatuses 10 are configured to move synchronously with each other.

As shown in FIG. 5, plural cam faces 44 are provided at an outer circumference of the cam member 35. In a state where the pawl 30 is held by the lower bracket 21, a base end portion of the pawl 30 is positioned inwardly in the radial direction, and includes a contact portion 45 which is in contact with each of the cam faces 44. The shape of the cam face 44 is defined so as to move a contact point of the cam face 44 and the mating contact portion 45 in the radial direction in response to the rotation of the cam member 35.

Specifically, the seat reclining apparatus 10 of the embodiment is configured such that the contact point of the cam face 44 and the contact portion 45 moves outwardly in the radial direction in response to the relative rotation of the cam member 35 in a locking direction (in the clockwise direction in FIG. 5). Accordingly, in the embodiment, the outer teeth 34 of the pawl 30 are meshed (engaged) with the inner teeth 33 of the upper bracket 22 by moving (extending) the pawl 30 outwardly in the radial direction.

As shown in FIG. 6 and FIG. 7, the pawl 30 of the embodiment includes a plate-shaped protection portion 30b. The protection portion 30b includes the level different from a body portion 30a which includes the outer teeth 34 and the contact portion 45 relative to the cam member 35. The protection portion 30b is positioned closer to the upper bracket 22 (left side in FIG. 7) relative to the cam member 35 so as to cover the circumferential edge portion of the cam member 35, in particular, the protection portion 30b is positioned radially inward of the second circumferential portion 24B. The protection portion 30b is provided with a cam groove 46 which penetrates the protection portion 30b in the thickness direction. Specifically, the cam groove 46 is formed in a long-hole shape which obliquely intersects a center line M which divides the pawl 30 into two in the circumferential direction. Then, the cam member 35 includes an engagement projection 47 which protrudes toward the protection portion 30b and engages with the cam groove 46.

That is, in the embodiment, the cam member 35 includes the engagement projection 47 which engages with the cam groove 46, and the engagement projection 47 moves within the cam groove 46 so that the pawl 30 moves along the guide portion 31 in the radial direction. As shown in FIG. 6, the cam member 35 rotates in an unlocking direction (in the anti-clockwise direction) so that the cam groove 46 moves (pulls) the pawl 30 inwardly in the radial direction based on the engagement state of the cam groove 46 and the mating engagement projection 47.

As shown in FIG. 4, in the embodiment, a torsion coil spring 48 fits onto the support shaft 42 serving as the rotation shaft L′ of the cam member 35. As shown in FIG. 5 and FIG. 6, the cam member 35 is rotationally biased in the clockwise direction, that is, in the locking direction in response to elastic force applied by the torsion coil spring 48.

According to the seat reclining apparatus 10 of the embodiment, in a state where the operation lever is not operated, the pawl 30 is positioned outwardly in the radial direction, The outer teeth 34 of the pawl 30 mesh with the inner teeth 33 of the upper bracket 22 so that the relative rotation between the upper bracket 22 and the lower bracket 21 is restricted, that is, the seatback 3 is prevented from tilting forward and backward. Accordingly, the locked state is established.

On the other hand, in a state where the operation lever is operated and the cam member 35 rotates in the unlocking direction (in the anti-clockwise direction in FIG. 5 and FIG. 6) against the elastic force applied by the torsion coil spring 48, the pawl 30 moves inwardly in the radial direction. Then, the outer teeth 34 of the pawl 30 disengages from the inner teeth 33 of the upper bracket 22 so that the upper bracket 22 and the lower bracket 21 relatively rotate with each other, that is, the tilt angle of the seatback 3 may be desirably changed. Accordingly, the unlocked state is established.

As shown in FIG. 5, according to the embodiment, one of the pawls 30 (a first pawl 30B) includes a recessed portion 50 between the side wall portion 32a of the holding protrusion 32 which is slidably in contact with the pawl 30B and the cam face 44 of the cam member 35. The recessed portion 50 holds a spherical cam 49. According to the seat reclining apparatus 10 of the embodiment, the spherical cam 49 serves as a wedge and fills in a clearance provided between the guide portion 31 and the pawl 30 in the circumferential direction. Thus, the seatback 3 is prevented from shaking when the seatback 3 is in the locked state.

As shown in FIG. 6, according to the embodiment, the second circumferential wall portion 24B includes a protruding portion 51 protruding inwardly in the radial direction. Specifically, the protruding portions 51 are provided at plural positions (for example, three positions) at equal angular intervals, or equally spaced with each other in the circumferential direction of the second circumferential wall portion 24B. Then, the seat reclining apparatus 10 of the embodiment is configured such that the protruding portion 51 serves as a control protrusion 52 which controls the movement of the pawl 30 by coming in contact with the pawl 30.

As shown in FIG. 1 and FIG. 2, according to the seat 1 of the embodiment, the seatback side members 13 correspond to the framework of the seatback 3, and the seatback 3 is rotationally biased in a forward tilting direction, or a forward inclining direction (in the clockwise direction in FIG. 3) in response to the elastic force applied by spiral springs 53 which are provided at the respective seatback side members 13 outwardly in the width direction.

That is, in a state where the unlocking operation is performed by the operation lever, the outer teeth 34 of the pawl 30 are disengaged from the inner teeth 33 of the upper bracket 22. Accordingly, the upper bracket 22 which is fixed by the seatback side member 13 is forced to rotate in the forward tilting direction (in the clockwise direction in FIG. 6) of the seatback 3.

According to the embodiment, in a state where the cam member 35 rotates further toward the unlocking direction, the pawl 30 moves inwardly in the radial direction to a position where an engagement protruding portion 54 of the pawl 30 does not come in contact with the control protrusion 52 in the circumferential direction. Thus, the seatback 3 is able to tilt forward.

Further, according to the embodiment, in a case where the seatback 3 is in the forward tilting state, an outer surface of the engagement protruding portion 54 of the pawl 30 in the radial direction slidably comes in contact with an inner surface of the control protrusion 52 which is positioned outwardly in the radial direction in the radial direction. Accordingly, the pawl 30 is prevented from moving radially outward so that the tilt angle of the seatback 3 which is in the forward-tilting state may be changed without maintaining the unlocking operation by the operation lever.

Next, the fixing structure of the seat reclining apparatus 10 which is configured as above will be explained.

As above, according to the seat reclining apparatus 10 of the embodiment, the upper bracket 22 configures the first bracket and includes the body portion 22a. The body portion 22a includes the first and second circumferential wall portions 24A, 24B at the circumferential edge portion. The pawl 30 is positioned inwardly in the radial direction of the first and second circumferential wall portions 24A, 24B.

Specifically, as shown in FIG. 6 and FIG. 7, the body portion 30a of the pawl 30 is positioned radially inward of the first circumferential wall portion 24A, and includes the outer teeth 34 and the contact portion 45 which is positioned between the pawl 30 and the cam member 35. The protection portion 30b is positioned radially inward of the second circumferential wall portion 24B, the second circumferential wall portion 24B which is positioned radially inward of the first circumferential wall portion 24A and includes the different level from the first circumferential wall portion 24A. The protection portion 30b includes the cam groove 46 and the engagement protruding portion 54.

According to the embodiment, the upper bracket 22 includes the body portion 22a and the circumferential wall portions 24 (the first circumferential wall portion 24A and the second circumferential wall portion 24B) which are integrally formed by deformation processing (pressing) of a plate-shaped metal material. That is, when the first circumferential wall portion 24A is formed, an inner surface S1 of the upper bracket 22 is pushed toward an outer surface S2 of the upper bracket 22 (from right to left in FIG. 7) by deformation processing. Accordingly, an outer circumferential surface of the second circumferential portion 24B is formed. Further, when the second circumferential wall portion 24B is formed, the inner surface S1 is pushed toward the outer surface S2 by deformation processing. Accordingly, a step portion 60 (serving as a fit-in portion) is formed at the body portion 22a of the upper bracket 22. As shown in FIG. 4, according to the seat reclining apparatus 10 for the vehicle of the embodiment, the step portion 60 is provided at the upper bracket 22 and serves as a fit-in portion to be fixed to the seatback side member 13 which serves as the fixed object Pb.

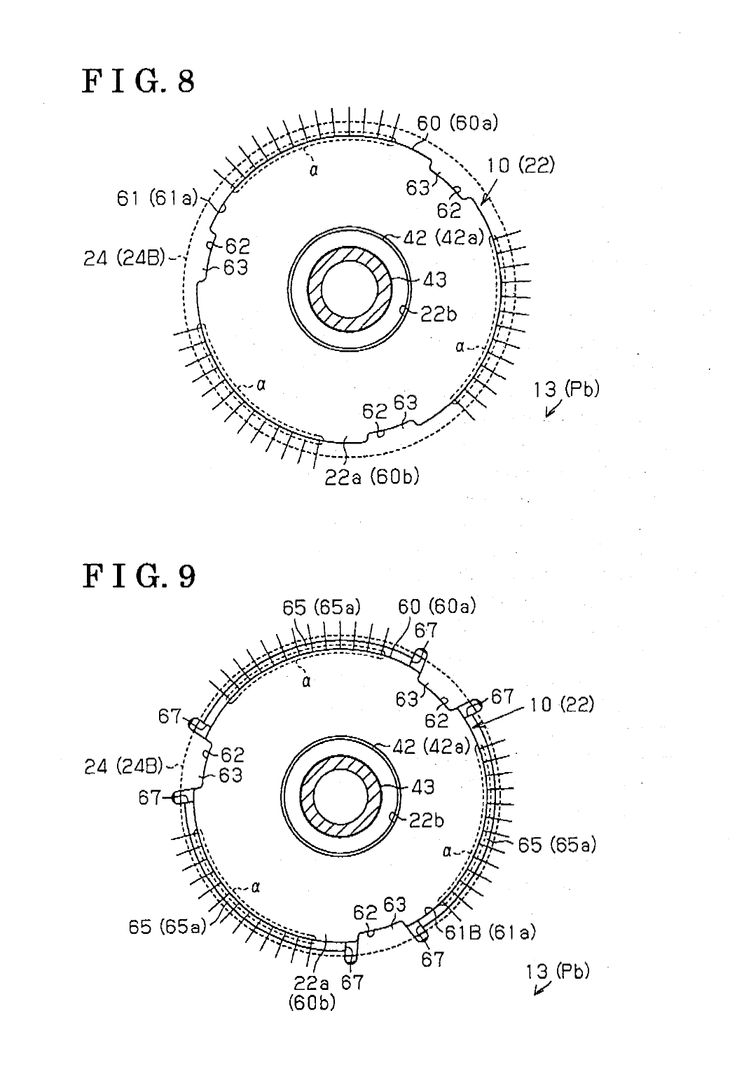

Specifically, as shown in FIG. 8, when the protruding portion 51 is formed at the second circumferential wall portion 24B, an outer circumferential surface 60a of the step portion 60 is formed with protrusions and recessed portions in the radial direction which are generated by deformation processing. Further, in the embodiment, the seatback side member 13 is configured with a fit-in recessed portion 61 at an inner circumferential edge 61a. The fit-in recessed portion 61 includes protrusions and recessed portions which are substantially equal to the protrusions and recessed portions of the outer circumferential surface 60a of the step portion 60. Then, the upper bracket 22 is fixed to the seatback side member 13 as such that the step portion 60 fits-in the fit-in recessed portion 61.

In particular, the outer circumferential surface 60a of the step portion 60 includes a recessed portion 62 which is formed in accordance with the formation of the protruding portion 51 by deformation processing and is recessed inwardly in the radial direction. The inner circumferential edge 61a of the fit-in recessed portion 61 includes a protrusion 63. The protrusion 63 protrudes inwardly in the radial direction to accord with the recessed portion 62. According to the embodiment, the recessed portion 62 of the step portion 60 engages with the protrusion 63 of the fit-in recessed portion 61 so that the relative rotation between the upper bracket 22 and the seatback side member 13 is restricted.

According to the embodiment, the upper bracket 22 is welded to the seatback side member 13 by having a welding portion a on the circumferential edge of the step portion 60. Specifically, according to the seat reclining apparatus 10 of the embodiment, the upper bracket 22 is fixed to the seatback side member 13 as such that the step portion 60 fits-in the fit-in recessed portion 61, and the step portion 60 is welded to the fit-in recessed portion 61. Further, the welding portion α is positioned away from the recessed portion 62 which is provided at the step portion 60 in the circumferential direction, that is, away from the protruding portion 51 which is provided at the second circumferential wall portion 24B in the circumferential direction. The upper bracket 22 is arc-welded at the welding portion a to be fixed to the seatback side member 13.

Next, the effect of the fixing structure of the seat reclining apparatus 10 which is configured as above will be explained. According to the embodiment, the protruding portion 51 is provided at the second circumferential wall portion 24B and serves as the control protrusion 52 which controls the movement of the pawl 30. The recessed portion 62 is formed in accordance with the formation of the protruding portion 51 and is positioned at the outer circumferential surface 60a of the step portion 60. The recessed portion 62 engages with the protrusion 63 which is provided at the fit-in recessed portion 61 of the seatback side member 13 so that the relative rotation between the upper bracket 22 and the seatback side member 13 is restricted.

In a case where the upper bracket 22 is welded and fixed, heat may affect the upper bracket 22 (for example, distortion due to heat, or the lower stiffness due to annealing treatment). Considering above, according to the embodiment, the welding portion a is positioned away from the protruding portion 51 (recessed portion 62) in the circumferential direction. Accordingly, the required strength of the control protrusion 52 (and a stopper for regulating the relative rotation of the upper bracket 22 and the seatback side member 13) is assured.

Next, effects and advantages of the embodiment of the disclosure will be described,

The upper bracket 22 configuring the first bracket includes the first and second circumferential wall portions 24A, 24B which are formed to include different levels from each other. The first circumferential wall portion 24A is provided with the inner teeth 33 which selectively engage with the outer teeth 34 of the pawl 30. The upper bracket 22 includes the body portion 22a and the circumferential wall portion 24 which are integrally formed by deformation processing (pressing) of the plate-shaped metal material. When the second circumferential wall portion 24B of the upper bracket 22 is formed by pushing out the inner surface S1 toward the outer surface S2, the step portion 60 is formed. The step portion 60 serves as the fit-in portion and fits-in the fit-in recessed portion 61 which is provided at the seatback side member 13 which serves as the fixed object Pb. The upper bracket 22 is welded to the seatback side member 13 by including the welding portion a on the circumferential edge of the step portion 60.

According to the known seat reclining apparatus for the vehicle, an outer surface of the upper bracket includes a fixing protrusion which protrudes in the thickness direction of the seat reclining apparatus. In comparison, according to the aforementioned configuration, the upper bracket 22 may be fixed to the seatback side member 13 without including the fixing protrusion. Further, the welding portion a is provided at the circumferential edge of the step portion 60. The step portion 60 and the first circumferential wall portion 24A which includes the inner teeth 33 at the inner circumferential surface 24s interpose the second circumferential wall portion 24B therebetween. Because the second circumferential wall portion 24B includes the different level from the first circumferential wall portion 24A, heat may less affect the inner teeth 33. For example, the distortion due to heat or the lower stiffness due to annealing treatment may be prevented. Thus, the seat reclining apparatus 10 may be thinner without decreasing the strength.

The second circumferential wall portion 24B includes the plural protruding portions 51 protruding inwardly in the radial direction. The protruding portion 51 serves as the control protrusion 52 which controls the movement of the pawl 30 by coming in contact with the pawl 30. Further, the welding portion a is positioned away from the protruding portion 51 in the circumferential direction.

According to the aforementioned embodiment, the protruding portion 51 is less affected by heat generated by the welding process. Thus, the required strength of the control protrusion 52 is assured to maintain the smooth movement of the pawl 30.

The outer circumferential surface 60a of the step portion 60 includes the recessed portion 62 which is recessed inwardly in the radial direction, and is formed when the protruding portion 51 is formed by deformation processing. The inner circumferential edge 61a of the fit-in recessed portion 61 includes the protrusion 63. The protrusion 63 protrudes inwardly in the radial direction to accord with the recessed portion 62. According to the embodiment, the recessed portion 62 of the step portion 60 engages with the protrusion 63 of the fit-in recessed portion 61 so that the relative rotation between the upper bracket 22 and the seatback side member 13 is restricted.

According to the aforementioned configuration, the upper bracket 22 may be easily positioned with a simple configuration. Further, because the welding portion α is positioned away from the protruding portion 51 in the circumferential direction, the recessed portion 62 is less affected by heat generated by the welding process. Accordingly, the required strength of the stopper for regulating the relative rotation of the upper bracket 22 with the seatback side member 13 is assured.

The aforementioned configuration may be changed, or modified as follows.

According to the aforementioned embodiment, the upper bracket 22 serving as the first bracket and including the inner teeth 33 is fixed to (the base end 13a of) the seatback side member 13 which serves as the fixed object Pb of the seatback 3. In addition, the lower bracket 21 serving as the second bracket and holding each of the pawls 30 is fixed to (the upper end portion 12a of) the support bracket 12 which serves as the fixed object Pc of the seat cushion 2. Alternatively, the first bracket is fixed to the fixed object Pc of the seat cushion 2, whereas the second bracket is fixed to the fixed object Pb of the seatback 3. In addition, the fixed objects Pb, Pc may be provided at any positions.

According to the aforementioned embodiment, the cam mechanism 40 is configured with the cam member 35, the protection portion 30b of the pawl 30, and the torsion coil spring 48 which rotationally biases (the support shaft 42 of) the cam member 35. Alternatively, the cam mechanism 40 may be configured desirably.

According to the aforementioned embodiment, the seat reclining apparatus 10 includes, for example, the three pawls 30. Alternatively, any numbers of the pawls 30 and the guide portions 31 may be provided. In addition, any number of the protruding portions 51 may be provided at the second circumferential wall portion 24B, whereas any number of the recessed portions 62 may be provided at the outer circumferential surface 60a of the step portion 60. Further, the outer circumferential surface 60a of the step portion 60 may be formed without the recessed portion 62.

According to the embodiment, when the protruding portion 51 is formed at the second circumferential wall portion 24B, the outer circumferential surface 60a of the step portion 60 is formed with protrusions and recessed portions in the radial direction which are generated by deformation processing. Further, according to the embodiment, the seatback side member 13 is configured with the fit-in recessed portion 61 at the inner circumferential edge 61a, the fit-in recessed portion 61 including protrusions and recessed portions which are substantially equal to the protrusions and recessed portions of the outer circumferential surface 60a of the step portion 60. Then, the upper bracket 22 is fixed to the seatback side member 13 as such that the step portion 60 fits-in the fit-in recessed portion 61. Alternatively, the fit-in recessed portion may be provided at the fixed target in any desirable form. In addition, for example, the step portion 60 may be formed to freely fit-in the fit-in recessed portion 61.

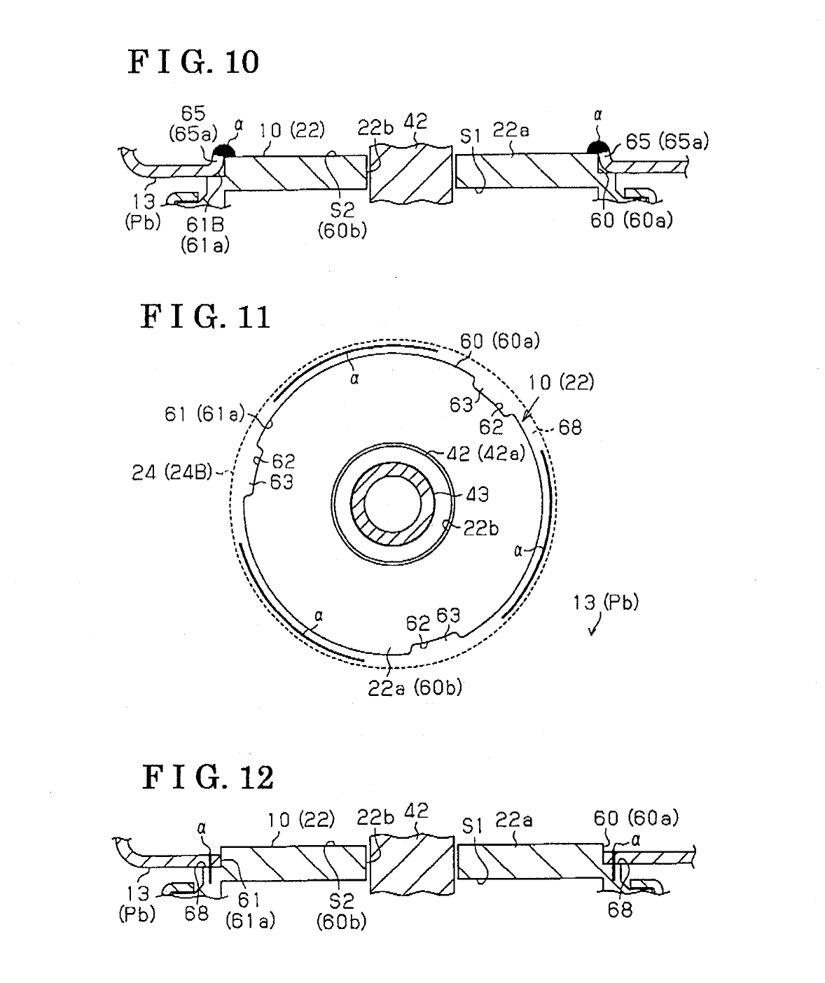

As shown in FIG. 9 and FIG. 10, according to a second embodiment of a seat reclining apparatus 10 for a vehicle, the inner circumferential edge 61a of a fit-in recessed portion 61B includes a bending portion 65. The bending portion 65 includes an end 65a which faces a top surface 60b of the step portion 60 when the bending portion 65 is bent by fitting-in the step portion 60 of the upper bracket 22. According to the second embodiment of the seat reclining apparatus 10 for the vehicle, the step portion 60 is welded to the bending portion 65, in particular, welded to the end 65a.

The inner diameter of the fit-in recessed portion 61B is set such that the inner circumferential edge 61a of the fit-in recessed portion 61B substantially accords with the recessed portion 62 which is provided at the outer circumferential surface 60a of the step portion 60. Further, the protrusion 63 engages with the recessed portion 62 and includes groove portions 67. The groove portions 67 are positioned at opposing ends of the protrusion 63 in the width direction (in the circumferential direction) and extend outwardly in the radial direction. Accordingly, in a case where the fit-in recessed portion 61B fits-in and fixed with the step portion 60, the bending portion 65 is pushed into the step portion 60.

According to the aforementioned configuration, the welding portion a may be away from the inner teeth 33 which are formed at the first circumferential wall portion 24A. Thus, the inner teeth 33 may be less affected by heat generated by the welding process. Alternatively, the bending portion 65 may not necessarily be welded at the end 65a as long as the inner teeth 33 are away from the welding portion α.

According to the embodiment, the upper bracket 22 and the seatback side member 13 are arc-welded with each other. Alternatively, as shown in FIG. 11 and FIG. 12, according to a third embodiment of a seat reclining apparatus 10 for a vehicle, the upper bracket 22 and the seatback side member 13 may be laser-welded. In this case, the circumferential edge of the step portion 60 is preferably provided with a flat surface 68 which is in surface-contact with the seatback side member 13 which serves as the fixed member Pb. According to the third embodiment of the seat reclining apparatus 10 for the vehicle, the flat surface 68 serves as the welding portion a and the upper bracket 22 is laser-welded to be stably fixed to the seatback side member 13.

According to the aforementioned embodiments, the seat reclining apparatus 10 for the vehicle includes the first bracket (the upper bracket 22) including the inner teeth 33 at the annular inner circumferential surface 24s of the first bracket (the upper bracket 22), the plural pawls 30, 30B including the outer teeth 34 which engage with and disengage from the inner teeth 33, the second bracket (the lower bracket 21) including the guide portion 31 which holds each of the pawls 30, 30B, the pawls 30, 30B which move in the radial direction, the second bracket (the lower bracket 21) being relatively rotatably placed to face the first bracket (the upper bracket 22), the cam member 35 being provided radially inward of the pawls 30, 30B, the cam mechanism 40 having the outer teeth 34 of each of the pawls 30, 30B engage with and disengage from with the inner teeth 33 of the first bracket (the upper bracket 22) by moving each of the pawls 30, 30B in the radial direction by rotating the cam member 35, the first bracket (the upper bracket 22) including the first circumferential wall portion 24A and the second circumferential wall portion 24B which are formed to include different levels from each other by the deformation processing, the first bracket (the upper bracket 22) including the inner teeth 33 at the first circumferential wall portion 24A, and the step portion 60 being formed by pushing the first bracket (the upper bracket 22) toward the outer surface S2 of the first bracket (the upper bracket 22) when forming the second circumferential wall portion 24B, the step portion 60 serving as the fit-in portion and being fitted-in the fit-in recessed portion 61, 61B being provided at the fixed object Pb of the seat 1, and the step portion 60 including the welding portion a at the circumferential edge to be welded to the fixed object Pb.

According to a known seat reclining apparatus for the vehicle, an outer surface of an upper bracket includes a fixing protrusion which protrudes in the thickness direction of the seat reclining apparatus. In comparison, according to the aforementioned configuration, the upper bracket 22 may be fixed to the fixed object Pb without including the fixing protrusion. Further, the welding portion a is provided at the circumferential edge of the step portion 60. The step portion 60 and the first circumferential wall portion 24A which includes the inner teeth 33 at the inner circumferential surface 24s interpose the second circumferential wall portion 24B therebetween. Because the second circumferential wall portion 24B includes the different level from the first circumferential wall portion 24A, heat may less affect the inner teeth 33. For example, the distortion due to heat or the lower stiffness due to annealing treatment may be prevented. Thus, the seat reclining apparatus 10 may be thinner without decreasing the strength.

According to the aforementioned embodiments, the second circumferential wall portion 24B includes the protruding portion 51 protruding inwardly in the radial direction, and the welding portion α is positioned away from the protruding portion 51 in the circumferential direction.

According to the aforementioned embodiment, the protruding portion 51 serves as an engagement protruding portion which engages with an engaged object. Accordingly, the protruding portion 51 is less affected by heat generated by the welding process. Thus, the required strength of the control protrusion 52 is assured.

According to the aforementioned embodiments, the protruding portion 51 controls the movement of each of the pawls 30, 30B by coming in contact with each of the pawls 30, 30B.

According to the aforementioned embodiment, the required strength of the protruding portion 51 (i.e., control protrusion 52) is assured.

According to the aforementioned embodiments, the first bracket (the upper bracket 22) includes the recessed portion 62 being formed at the outer circumferential surface 60a of the step portion 60, the recessed portion 62 being formed in accordance with the formation of the protruding portion 51, and the recessed portion 62 engages with the protrusion 63 which is provided at the inner circumferential edge 61 a of the fit-in recessed portion 61, 61B so that the relative rotation of the first bracket (the upper bracket 22) with the fixing object Pb is restricted.

According to the aforementioned configuration, the upper bracket 22 may be easily positioned with a simple configuration. The required strength of the stopper for regulating the relative rotation of the upper bracket 22 with the seatback side member 13 is assured.

According to the aforementioned embodiment, the seat reclining apparatus 10 for the vehicle further includes the bending portion 65 being provided at the inner circumferential edge 61a of the fit-in recessed portion 61B, the bending portion 65 including the end 65a which faces the top surface 60b of the step portion 60 in a state where the bending portion 65 is bent by fitting-in the step portion 60. Then, the step portion 60 is welded to the bending portion 65.

According to the aforementioned configuration, the welding portion a may be away from the inner teeth 33 which are formed at the first circumferential wall portion 24A. Thus, the inner teeth 33 may be less affected by heat generated by the welding process.

According to the aforementioned embodiment, the seat reclining apparatus (10) for the vehicle further includes the flat surface 68 being provided at the circumferential edge of the step portion 60, the flat surface 68 being in surface-contact with the fixed object Pb, and the flat surface 68 serving as the welding portion a and being laser-welded to the step portion (60).

According to the aforementioned configuration, the upper bracket 22 may be stably fixed to the seatback side member 13.

According to the embodiment, the seat reclining apparatus 10 may be thinner without decreasing the strength.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A seat reclining apparatus for a vehicle, comprising:
a first bracket including inner teeth at an annular inner circumferential surface of the first bracket;
a plurality of pawls including outer teeth which engage with and disengage from the inner teeth;
a second bracket including a guide portion which holds each of the pawls, the pawls which move in a radial direction, the second bracket being relatively rotatably placed to face the first bracket;
a cam member being provided radially inward of the pawls;
a cam mechanism having the outer teeth of each of the pawls engage with and disengage from the inner teeth of the first bracket by moving each of the pawls in the radial direction by rotating the cam member;
the first bracket including a first circumferential wall portion and a second circumferential wall portion which are formed to include different levels from each other by a deformation processing, the first bracket including the inner teeth at the first circumferential wall portion; and
a step portion being formed by pushing the first bracket toward an outer surface of the first bracket when forming the second circumferential wall portion, the step portion serving as a fit-in portion and being fitted-in a fit-in recessed portion being provided at a fixed object of a seat, and the step portion including a welding portion at a circumferential edge to be welded to the fixed object.

2. The seat reclining apparatus for the vehicle according to claim 1, wherein the second circumferential wall portion includes a protruding portion protruding inwardly in the radial direction; and
the welding portion is positioned away from the protruding portion in a circumferential direction.

3. The seat reclining apparatus for the vehicle according to claim 2, wherein the protruding portion controls a movement of each of the pawls by coming in contact with each of the pawls.

4. The seat reclining apparatus for the vehicle according to claim 2, wherein the first bracket includes a recessed portion being formed at an outer circumferential surface of the step portion, the recessed portion being formed in accordance with a formation of the protruding portion; and
the recessed portion engages with a protrusion which is provided at an inner circumferential edge of the fit-in recessed portion so that a relative rotation of the first bracket with the fixing object is restricted.

5. The seat reclining apparatus for the vehicle according to claim 1, further comprising:
a bending portion being provided at the inner circumferential edge of the fit-in recessed portion, the bending portion including an end which faces a top surface of the step portion in a state where the bending portion is bent by fitting-in the step portion, and wherein
the step portion is welded to the bending portion.

6. The seat reclining apparatus for the vehicle according to claim 1, further comprising:
a flat surface being provided at the circumferential edge of the step portion, the flat surface being in surface-contact with the fixed object, and the flat surface serving as the welding portion and being laser-welded to the step portion.

7. The seat reclining apparatus for the vehicle according to claim 3, wherein the first bracket includes a recessed portion being formed at an outer circumferential surface of the step portion, the recessed portion being formed in accordance with a formation of the protruding portion; and
the recessed portion engages with a protrusion which is provided at an inner circumferential edge of the fit-in recessed portion so that a relative rotation of the first bracket with the fixing object is restricted.
